(19) United States
(12) Patent Application Publication
(10) Pub. No.: US 2005/0269013 A1
(43) Pub. Date: Dec. 8, 2005

(54) Method for manufacturing monolithic ceramic electronic component

(76) Inventors: Hidetaka Fukudome, Sabae-shi (JP); Masaaki Taniguchi, Fukui-ken (JP); Yoshio Kawaguchi, Sabae-shi (JP)

Correspondence Address: KEATING & BENNETT, LLP, 8180 GREENSBORO DRIVE, SUITE 850, MCLEAN, VA, 22102, US

(21) Appl. No.: 11/142,594

(22) Filed: Jun. 1, 2005

(30) Foreign Application Priority Data
Jun. 4, 2004 (JP) 2004-167248

(51) Int. Cl. C03B 29/00

(52) U.S. Cl. 156/89.11

(57) ABSTRACT

A first laminate block including inner conductors is manufactured, and thin holes are formed in the first laminate block so as to extend between top and bottom surfaces of the first laminate block. The thin holes are filled with conductive paste to form via holes. Then, a ceramic sheet layer is laminated on the bottom surface of the first laminate block, and a second laminate block including inner conductors is laminated on the bottom surface of the ceramic sheet layer to obtain a laminate body. Then, thin holes are formed in the laminate body so as to extend between top and bottom surfaces of the laminate body, and are filled with conductive paste to obtain through via hole.

### BACKGROUND OF THE INVENTION

1. Field of the Invention

The present invention relates to methods for manufacturing monolithic ceramic electronic components, and more specifically to a method for manufacturing a monolithic ceramic electronic component obtained by laminating a plurality of ceramic sheets with inner conductors interposed therebetween.

2. Description of the Related Art

Recently, monolithic capacitors used in high-frequency circuits have been required to have low equivalent series inductance (ESL), and a monolithic ceramic electronic component which satisfies this requirement has been suggested in Japanese Unexamined Patent Application Publication No. 2001-185442. In this electronic component, in order to reduce ESL, through via holes and non-through via holes, which are electrically connected to inner conductors, are formed in a laminate body so that the lengths and numbers of current-conducting paths can be reduced and generated magnetic fluxes can be canceled.

The through via holes are via holes which extend between the top and bottom surfaces of the laminate body, and the non-through via holes are via holes which extend between one of the top and bottom surfaces and a position inside the laminate body.

More specifically, as shown in FIG. 6, a monolithic ceramic electronic component 50 is structured such that a plurality of layers of inner conductors (capacitor electrodes and the like) 55 are formed in a laminate body 51 of a plurality of ceramic sheets. The inner conductors 55 are electrically connected to one another with through via holes 61 and non-through via holes 62 formed in the laminate body 51, and a predetermined circuit is formed accordingly.

This electronic component 50 is typically manufactured by a method shown in FIGS. 7A to 7C. First, as shown in FIG. 7A, a laminate body 51 including the inner conductors 55 is manufactured from a plurality of ceramic sheets. Then, as shown in FIG. 7B, thin through holes 61′ and thin non-through holes 62′ are formed. Then, the thin holes 61′ and 62′ are filled with conductive paste to obtain the through via holes 61 and the non-through via holes 62, as shown in FIG. 7C.

However, in the known manufacturing method, since the thin holes 62′ are closed at the bottom, when the conductive paste is injected in the thin holes 62′ to form the non-through via holes 62, air necessarily remains at the bottom of the thin holes 62′ and it is difficult to fill the thin holes 62′ with the conductive paste to the bottom. As a result, connection failure occurs between the non-through via holes 62 and the inner conductors 55, as shown in an enlarged view at the left in FIG. 7C.

Accordingly, a manufacturing method described in Japanese Unexamined Patent Application Publication No. 2002-344140 has been suggested. This manufacturing method will be described below with reference to FIG. 8. First, a first laminate block 52 including non-through via holes 62 and a second laminate block 53 which is free from non-through via holes 62 are separately formed. In this case, the through via holes 61 are separately formed in the first and second laminate blocks 52 and 53. Then, the first and second laminate blocks 52 and 53 are bonded together to obtain a laminate body 51.

However, in this manufacturing method, it is difficult to align the central axes of the separately formed through via holes 61 when the first and second laminate blocks 52 and 53 are bonded together. Accordingly, as shown in an enlarged view at the right in FIG. 8, there is a risk that the through via holes 61 will be connected to each other in a misaligned manner. In particular, electronic components with low ESL used in high-frequency circuits are very small, and there is a large possibility that the central axes will be misaligned. In such a case, ESL is increased and electrical characteristics cannot be maximized.

### SUMMARY OF THE INVENTION

In order to overcome the problems described above, preferred embodiments of the present invention provide a method for manufacturing a monolithic ceramic electronic component in which non-through via holes are connected to inner conductors with high reliability, and which does not cause connection failure in through via holes and degradation of electrical characteristics.

According to a preferred embodiment of the present invention, a method for manufacturing a monolithic ceramic electronic component including a laminate body obtained by laminating a plurality of ceramic sheets with inner conductors interposed between the ceramic sheets, the laminate body having a through via hole extending between top and bottom surfaces of the laminate body and a non-through via hole extending between one of the top and bottom surfaces of the laminate body and a position inside the laminate body, includes the steps of forming a via hole in a first laminate block in such a manner that the via hole extends through the first laminate block, laminating a ceramic sheet layer and/or a second laminate block on the first laminate block to obtain the laminate body such that the via hole is completely covered by the ceramic sheet layer and/or the second laminate block, and forming a through via hole in the laminate body obtained in the laminating step.

In the manufacturing method according to a preferred embodiment of the present invention, the via hole is formed in the first laminate block so as to extend through the first laminate block, and then the ceramic sheet layer and/or the second laminate block is/are laminated on the first laminate block such that the via hole is completely covered by the ceramic sheet layer and/or the second laminate block. Therefore, the via hole is completely filled with the conductive paste to the bottom, and the connection reliability between the non-through via hole and the inner conductor is increased.

In addition, the through via hole is preferably formed in the laminate body after the laminate body is obtained by laminating the ceramic sheet layer and/or the second laminate block on the first laminate block. In other words, the through via hole may be formed without using the method described in Japanese Unexamined Patent Application Publication No. 2002-344140. Accordingly, connection failure does not occur and required electrical characteristics (in particular, low ESL) can be maintained.

In the manufacturing method according to a preferred embodiment of the present invention, the second laminate block may include at least one of an inner conductor and a non-through via hole.

Other features, elements, steps, advantages and characteristics of the present invention will become more apparent from the following detailed description of preferred embodiments thereof with reference to the attached drawings.

### BRIEF DESCRIPTION OF THE DRAWINGS

FIGS. 1A to 1D are sectional views showing manufacturing steps according to a first preferred embodiment of the present invention;

FIGS. 2A to 2C are sectional views showing manufacturing steps performed after the manufacturing steps shown in FIGS. 1A to 1D;

FIG. 3 is a sectional view showing an electronic component manufactured by a method according to a second preferred embodiment of the present invention;

FIG. 4 is a sectional view showing an electronic component manufactured by a method according to a third preferred embodiment of the present invention;

FIG. 5 is a sectional view showing an electronic component manufactured by a method according to a fourth preferred embodiment of the present invention;

FIG. 6 is a sectional view showing an electronic component manufactured by a known method;

FIGS. 7A to 7C are sectional views showing known manufacturing steps (first example); and

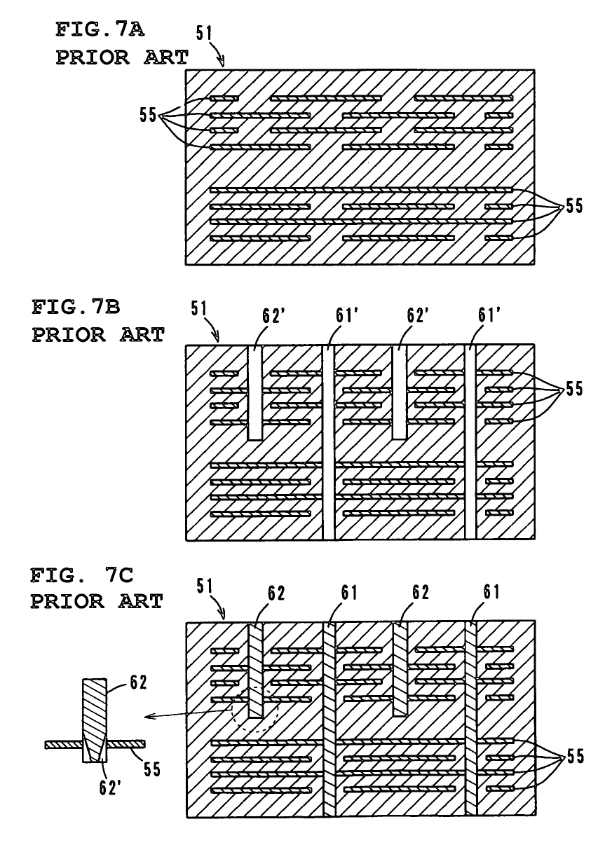

FIG. 8 is a sectional view showing another known manufacturing step (second example).

### DETAILED DESCRIPTION OF PREFERRED EMBODIMENTS

Methods for manufacturing monolithic ceramic electronic components according to preferred embodiments of the present invention will be described below with reference to the accompanying drawings.

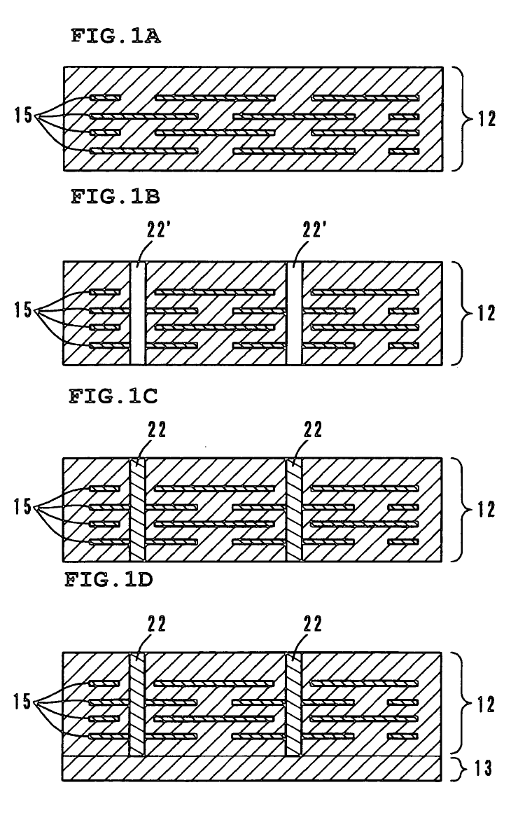

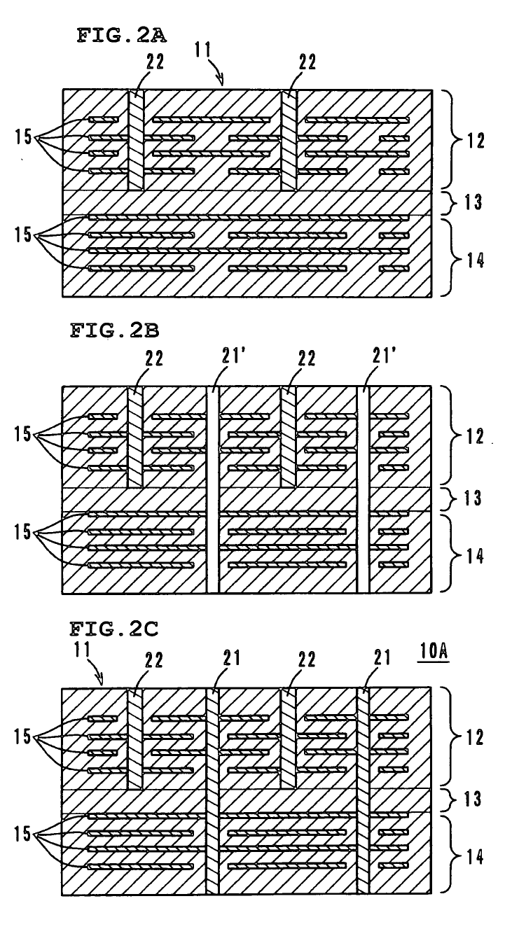

### First Preferred Embodiment (FIGS. 1A to 2C)

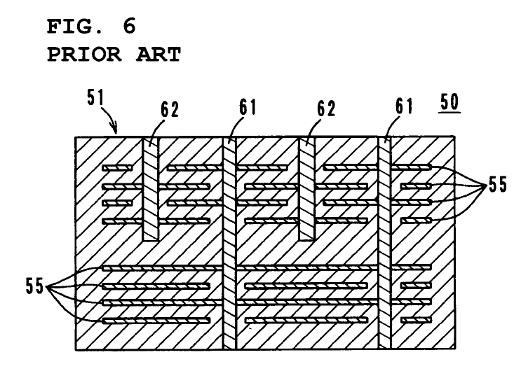

FIGS. 1A to 2C show a manufacturing method according to a first preferred embodiment of the present invention. As shown in FIG. 2C, a monolithic ceramic electronic component 10A manufactured by the method according to the first preferred embodiment is structured such that a plurality of layers of inner conductors (capacitor electrodes and the like) 15 are formed in a laminate body 11 including a plurality of ceramic sheets. The inner conductors 15 are electrically connected to one another by through via holes 21 and non-through via holes 22 formed in the laminate body 11, and a predetermined circuit is formed accordingly. The circuit structure of the monolithic ceramic electronic component 10A is similar to that of the known monolithic ceramic electronic component 50 shown in FIG. 6.

This monolithic ceramic electronic component 10A is manufactured by the following steps. That is, first, as shown in FIG. 1A, a first laminate block 12 is obtained by laminating a plurality of ceramic sheets with the inner conductors 15 interposed therebetween. The thickness of the first laminate block 12 corresponds to the depth of the via holes 22 (see FIG. 2C).

Next, as shown in FIG. 1B, thin holes 22′ are formed in the first laminate block 12 so as to extend between the top and bottom surfaces of the first laminate block 12. Then, as shown in FIG. 1C, the thin holes 22′ are filled with conductive paste. Thus, the via holes 22 are formed in the first laminate block 12 so as to extend through the first laminate block 12.

Next, a ceramic sheet layer 13 is laminated on the bottom surface of the first laminate block 12, as shown in FIG. 1D, and a second laminate block 14 is laminated on the bottom surface of the ceramic sheet layer 13, as shown in FIG. 2A. Accordingly, the laminate body 11 is obtained. The second laminate block 14 is obtained by laminating a plurality of ceramic sheets with inner conductors 15 interposed therebetween.

Then, as shown in FIG. 2B, thin holes 21′ are formed in the laminate body 11 obtained by the above-described steps so as to extend between the top and bottom surfaces of the laminate body 11. Then, the thin holes 21′ are filled with the conductive paste. Accordingly, as shown in FIG. 2C, the through via holes 21 are formed in the laminate body 11.

According to the first [referred embodiment, the via holes 22 are formed in the first laminate block 12 so as to extend through the first laminate block 12, and then the ceramic sheet layer 13 is laminated on the first laminate block 12. Therefore, the non-through via holes 22 are completely filled with the conductive paste to the bottom, and connection reliability between the non-through via holes 22 and the inner conductors 15 is increased.

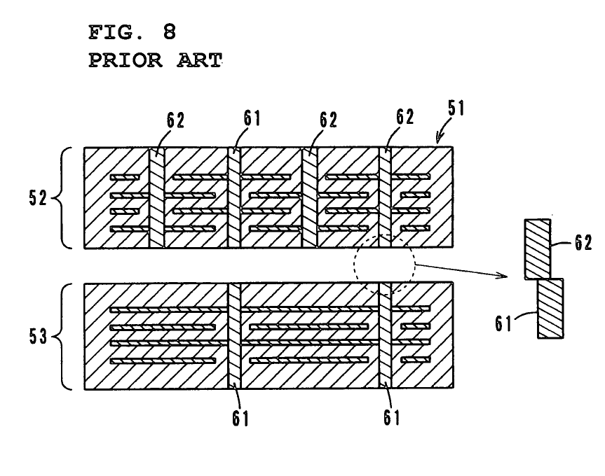

In addition, the through via holes 21 are formed in the laminate body 11 after the laminate body 11 is obtained by laminating the ceramic sheet layer 13 and the second laminate block 14 on the first laminate block 12. Therefore, the through via holes 21 are not divided in a manner shown in FIG. 8. Accordingly, connection failure due to misalignment of central axes and variation in electrical resistances do not occur and required electrical characteristics (in particular, low ESL) can be maintained.

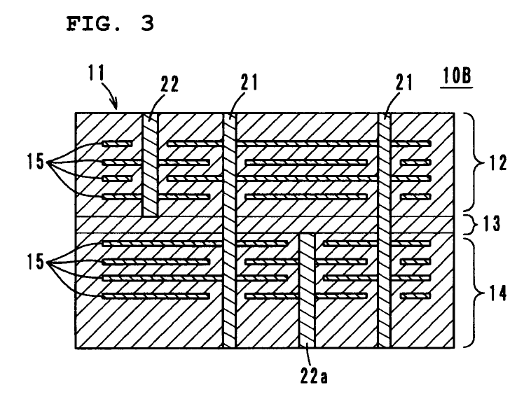

### Second Preferred Embodiment (FIG. 3)

As shown in FIG. 3, a monolithic ceramic electronic component 10B manufactured by a method according to a second preferred embodiment includes a second laminate block 14 which also has a non-through via hole 22a formed therein. In this case, the non-through via hole 22a, which extends to the bottom surface of the laminate body 11, is formed in the second laminate block 14 so as to extend through the second laminate block 14, and then the bottom surface of the non-through via hole 22a is closed by a ceramic sheet layer 13.

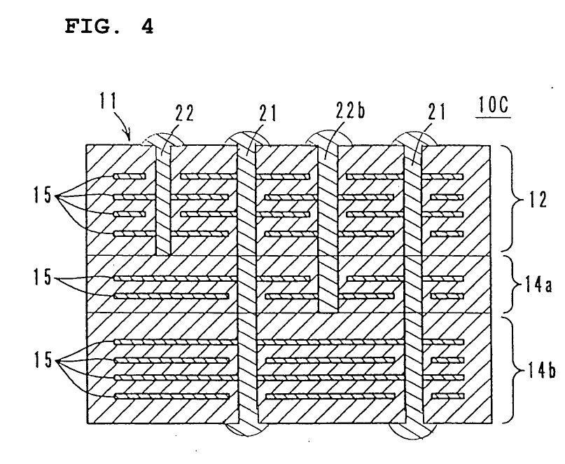

### Third Embodiment (See FIG. 4)

As shown in FIG. 4, a monolithic ceramic electronic component 10C manufactured by a method according to a third preferred embodiment includes non-through via holes 22 and 22b with different depths.

In this case, first, a non-through via hole 22 is formed in a first laminate block 12 having a thickness corresponding to the depth of the non-through via hole 22 so as to extend through the first laminate block 12 (see FIGS. 1A to 1C). Then, a second laminate block 14a including inner conductors 15 is laminated on the bottom surface of the first laminate block 12. The second laminate block 14a has a thickness corresponding to the depth of the non-through via hole 22b.

Next, a third laminate block 14b including inner conductors 15 is laminated on the bottom surface of the second laminate block 14a to obtain a laminate body 11. Then, thin holes for through via holes 21 are formed in the laminate body 11 and are filled with conductive paste, and the through via holes 21 are obtained accordingly.

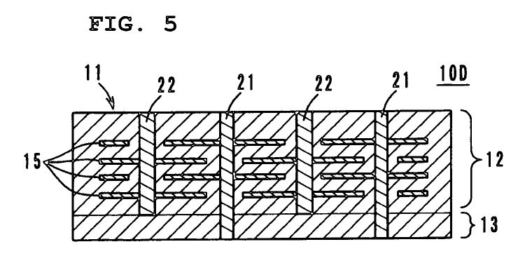

### Fourth Preferred Embodiment (FIG. 5)

As shown in FIG. 5, in a monolithic ceramic electronic component 10D manufactured by a method according to a fourth preferred embodiment, only a ceramic sheet layer 13 is laminated on the bottom surface of a first laminate block 12 to obtain a laminate body 11, and through via holes 21 are formed in this laminate body 11.

### Other Preferred Embodiments

The present invention is not limited to the methods for manufacturing the monolithic ceramic electronic components according to the above-described preferred embodiments, and various modifications are possible within the scope of the present invention.

For example, the shapes of the inner conductors included in the laminate body and the structure of the circuit formed by the inner conductors, the through via holes, and the non-through via holes may be determined arbitrarily.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1. A method for manufacturing a monolithic ceramic electronic component including a laminate body obtained by laminating a plurality of ceramic sheets with inner conductors interposed between the ceramic sheets, the laminate body having a through via hole extending between top and bottom surfaces of the laminate body and a non-through via hole extending between one of the top and bottom surfaces of the laminate body and a position inside the laminate body, the method comprising the steps of:
forming a via hole in a first laminate block in such a manner that the via hole extends through the first laminate block;
laminating at least one of a ceramic sheet layer and a second laminate block on the first laminate block to obtain the laminate body such that the via hole is completely covered by the at least one of the ceramic sheet layer and the second laminate block; and
forming a through via hole in the laminate body obtained in the laminating step.

2. The method according to claim 1, wherein the second laminate block includes an inner conductor.

3. The method according to claim 1, wherein the second laminate block has a non-through via hole.

4. The method according to claim 1, further comprising the step of forming a non-through via hole in one of the first and second laminated blocks so as to extend to a bottom surface of the at least one of the first and second laminated blocks.

5. The method according to claim 4, wherein a bottom surface of the non-through via hole closed by the ceramic sheet layer.

6. The method according to claim 1, further comprising the step of forming a plurality of non-through via holes in at least one of the first and second laminated blocks so as to have different depths in the second laminated block.
